(19) United States
(12) Patent Application Publication
(10) Pub. No.: US 2025/0044126 A1
(43) Pub. Date: Feb. 6, 2025

(54) TIP FOR OPTICAL FIBER INSPECTION DEVICE

(71) Applicant: VIAVI Solutions Inc., Chandler, AZ (US)

(72) Inventor: Kevin CASSADY, Monroe, WA (US)

(21) Appl. No.: 18/362,799

(22) Filed: Jul. 31, 2023

(51) Int. Cl. G01D 5/26

(52) U.S. Cl. CPC G01D 5/268

(57) ABSTRACT

A tip for an optical fiber inspection device includes a body portion that includes a first opening, a second opening, and a chamber that extends within the body portion from the first opening to the second opening. The body portion is configured to allow illumination light to enter through the first opening and to propagate to, and impinge on, a portion of a surface of the chamber. The portion of the surface of the chamber is configured to redirect the illumination light to allow the illumination light to propagate to, and exit through, the second opening and thereby propagate to an angled end face of an optical fiber. The body portion is configured to allow reflection light, reflected by the angled end face of the optical fiber, to enter through the second opening and to propagate through, and exit from, the chamber.

### BACKGROUND

An optical cable may include one or more optical fibers. The one or more optical fibers typically terminate at an end of the optical cable, such that respective end faces of the optical fibers are exposed. In many cases, the end faces should be free from dirt particles, dust particles, scratches, and/or other surface defects to ensure an optimal optical connection when the optical cable is connected to another optical cable or another optical device.

### SUMMARY

In some implementations, a tip for an optical fiber inspection device includes a body portion that includes a first end with a first opening, a second end with a second opening, and a chamber that extends within the body portion from the first opening of the first end to the second opening of the second end; and an optical element disposed on a surface of the chamber of the body portion, wherein: the body portion is configured to allow illumination light to enter through the first opening of the first end of the body portion and to propagate to, and impinge on, the optical element, the optical element is configured to redirect the illumination light to allow the illumination light to propagate to, and exit through, the second opening of the second end of the body portion and thereby propagate to an angled end face of an optical fiber, and the body portion is configured to allow reflection light, reflected by the angled end face of the optical fiber, to enter through the second opening of the second end of the body portion and to propagate to, and exit through, the first opening of the first end of the body portion and thereby propagate to the optical fiber inspection device.

In some implementations, a tip for an optical fiber inspection device includes a body portion that includes a first opening, a second opening, and a chamber that extends within the body portion from the first opening to the second opening, wherein: the body portion is configured to allow illumination light to enter through the first opening of the body portion and to propagate to, and impinge on, a portion of a surface of the chamber, the portion of the surface of the chamber is configured to redirect the illumination light to allow the illumination light to propagate to, and exit through, the second opening of the body portion and thereby propagate to an angled end face of an optical fiber, and the body portion is configured to allow reflection light, reflected by the angled end face of the optical fiber, to enter through the second opening of the body portion and to propagate through, and exit from, the chamber of the body portion and thereby propagate to the optical fiber inspection device.

In some implementations, an optical assembly includes a body portion that includes a first opening, a second opening, and a chamber that extends within the body portion from the first opening to the second opening, wherein: the body portion is configured to allow illumination light to enter through the first opening of the body portion and to propagate to, and impinge on, a portion of a surface of the chamber, the portion of the surface of the chamber is configured to redirect the illumination light to allow the illumination light to propagate to, and exit through, the second opening of the body portion and thereby propagate to an angled end face of an optical fiber, and the body portion is configured to allow reflection light, reflected by the angled end face of the optical fiber, to enter through the second opening of the body portion and to propagate through, and exit from, the chamber of the body portion.

### BRIEF DESCRIPTION OF THE DRAWINGS

FIGS. 1A-1C are diagrams of one or more example implementations described herein.

FIG. 2 is a diagram of an example implementation described herein.

FIGS. 3A-3B are diagrams of one or more example implementations described herein.

FIGS. 4A-4B are diagrams of one or more example implementations described herein.

FIGS. 5A-5B are diagrams of one or more example implementations described herein.

### DETAILED DESCRIPTION

The following detailed description of example implementations refers to the accompanying drawings. The same reference numbers in different drawings may identify the same or similar elements. The techniques, principles, procedures, and methods described herein may be used with any sensor implemented in a device having a tip that interfaces with an object or medium to be analyzed, including but not limited to other optical sensors and spectral sensors.

A technician may use a device, such as a handheld optical fiber microscope, to inspect an end face of an optical fiber of an optical cable prior to connecting the optical cable to network equipment. The device may include a light source to illuminate the end face of the optical fiber and an image sensor to capture images, live video, and/or the like, of an end face of the optical fiber so that the device (and/or another device) may analyze the images for dirt particles, dust particles, scratches, and/or other surface defects.

The device (e.g., the handheld optical fiber microscope) may use coaxial illumination to illuminate the end face of the optical fiber. Light emitted from the light source of the device reflects from a beam splitter of the device (e.g., a first portion of the light reflects, and a second portion of the light passes through) and passes through a lens of the device to the end face of the optical fiber. The light reflects back from the end face of the optical fiber to the device, passes back through the lens and forms an image of the end face of the optical fiber at the image sensor of the device. Such a technique is referred to as bright field illumination.

In many cases, the end face of the optical fiber may be recessed within a connector and/or a bulkhead adapter. Further, the optical fiber can have an angled end face (e.g., the optical fiber is an angled polish fiber), and consequently, reflected light (e.g., reflected illumination light) propagates from the end face at an angle (e.g., with respect to a propagation direction of the illumination light), such as toward a side portion of the connector and/or the bulkhead adapter, and not to the device. The image sensor of the device therefore is unable to capture an image of the angled end face of the optical fiber.

As a result, in some cases, the technician may need to remove the connector and/or the bulkhead adapter to position and orient the device relative to the angled end face of the optical fiber such that the angled end face of the optical fiber receives and reflects light back to the image sensor of the device. This increases a likelihood of damage to the connector, the bulkhead adapter, the optical cable, and the optical fiber (e.g., due to removing and reattaching the connector and/or the bulkhead adapter), and risks contaminating (or re-contaminating) the angled end face of the optical fiber.

Some implementations described herein include a tip, such as a tip for a device (e.g., an optical fiber inspection device, such as an optical fiber microscope). The tip includes a first end and a second end. The first end includes a first opening, and the second end includes a second opening. Accordingly, a chamber is formed within the body portion of the tip, and extends (e.g., within the body portion) from the first opening of the first end to the second opening of the second end. Further, the tip includes an optical element that is disposed on a surface of the chamber of the body portion of the tip. The optical element is configured to have at least one of a reflective characteristic, a refractive characteristic, or a non-diffractive characteristic. For example, the optical element may include a reflective element (e.g., a reflector, a mirror, or a similar element), a refractive element (e.g., a prism), and/or another type of non-diffractive element.

The body portion of the tip is configured to allow illumination light (e.g., from a light source of the device) to enter through the first opening of the first end of the body portion and to propagate to, and impinge on, the optical element. In some implementations, the illumination light may be associated with coaxial illumination (e.g., bright field illumination). For example, the illumination light may propagate via a lens of the device through the first opening of the first end of the body portion to the optical element.

The optical element is configured to redirect the illumination light, such as to allow the illumination light to propagate to, and exit through, the second opening of the second end 206 of the body portion and thereby propagate to an end face (e.g., an angled end face) of an optical fiber of an optical cable (e.g., that is positioned at an end of the optical cable and that is recessed within at least one of an optical connector or a bulkhead adapter). For example, the optical element may reflect, refract, or otherwise cause the illumination light to propagate to, and exit through, the second opening of the second end of the body portion, which allows the illumination light to propagate to the end face of the optical fiber of the optical cable.

Additionally, the body portion of the tip is configured to allow reflection light to enter through the second opening of the second end of the body portion and to propagate through, and exit from, the chamber of the body portion. For example, a portion of the illumination light that propagates to the angled end face of the optical fiber of the optical cable (e.g., after exiting through the second opening) may be reflected, by the end face of the optical fiber, back to the second opening. This reflection light (e.g., the reflected portion of the illumination light) then enters through the second opening and propagates through, and exits from, the chamber, such as via the first opening of the first end of the body portion (or another opening of the body portion).

In this way, the optical element, and the body portion of the tip, are configured to allow the reflection light to propagate to the device (e.g., after exiting from the chamber). For example, the reflection light may propagate to the lens of the device, may pass through the lens, and may form an image of the end face of the optical fiber at the image sensor of the device. This allows the device to image the end face (e.g., the angled end face) of the optical fiber (e.g., using coaxial illumination, such as bright field illumination), without an operator needing to remove one or more of the optical connector and the bulkhead adapter. This reduces a likelihood of damage to the optical connector, the bulkhead adapter, the optical cable, and the optical fiber (e.g., because the optical connector and the bulkhead adapter do not have to be removed and reattached), and thereby reduces a risk of contaminating (or re-contaminating) the angled end face of the optical fiber in associated with inspecting the angled end face. Further, because the optical element and the body portion of the tip enable co-axial illumination, such as bright field illumination, of the angled end face of the optical fiber, computing resources (e.g., processing resources, memory resources, communication resources, and/or power resources, among other examples) are conserved that would otherwise have been wasted in performing incorrect inspections of end faces of optical fibers (e.g., due to improper or insufficient illumination), incorrectly determining that faulty optical fibers are functional, implementing faulty optical fibers in networks, and/or losing network data because of the faulty optical fibers, among other examples.

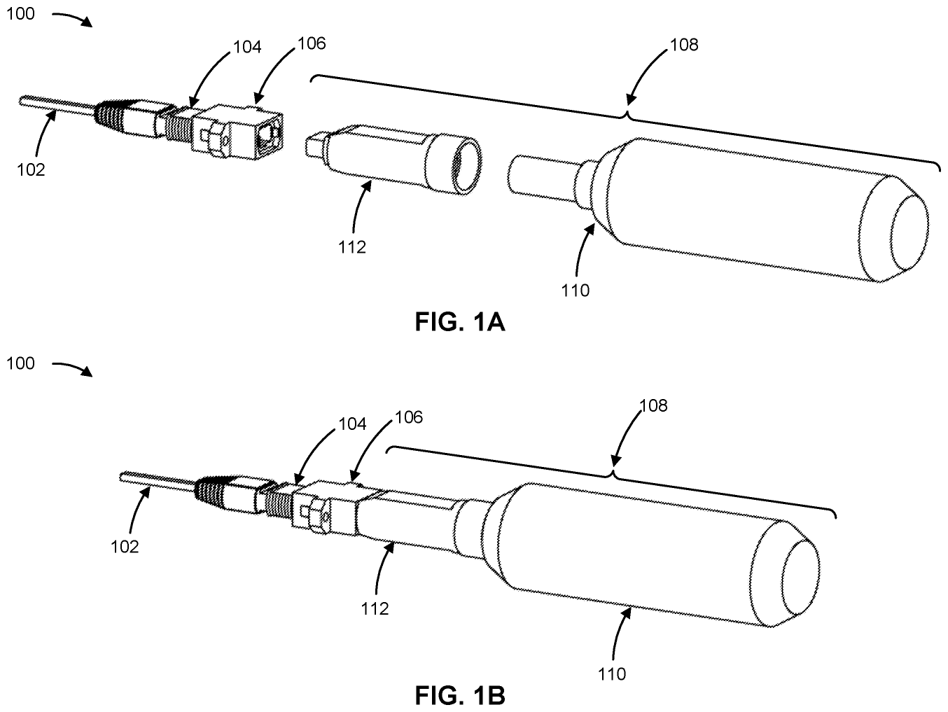

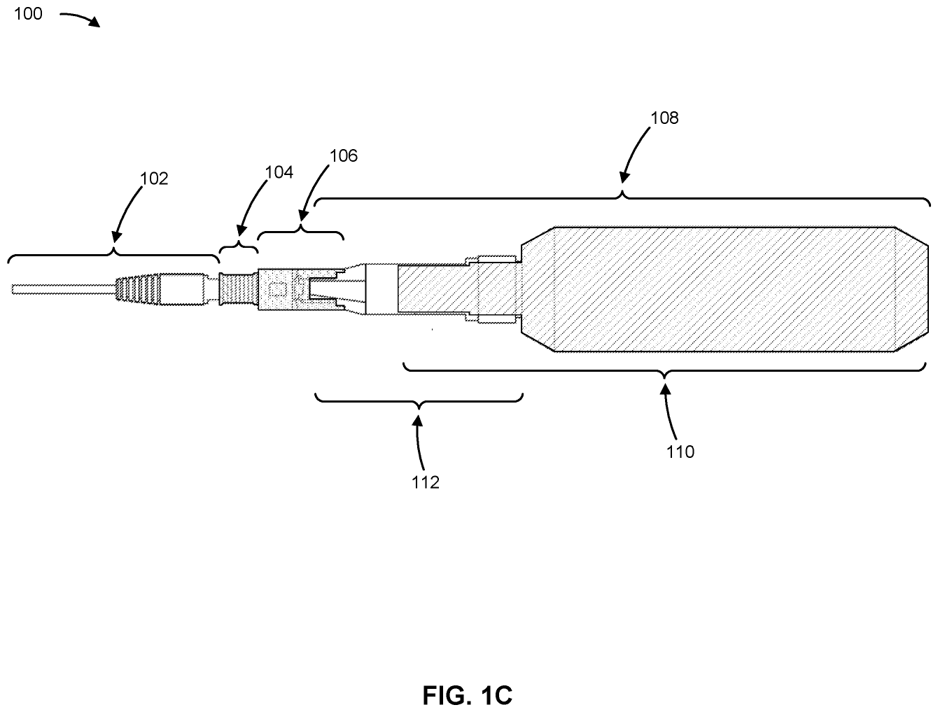

FIGS. 1A-1C are diagrams of one or more example implementations 100 described herein. As shown in FIG. 1A, example implementation(s) 100 may include an optical cable 102, an optical connector 104, a bulkhead adapter 106, and an optical fiber inspection system 108 that includes a device 110 (e.g., an optical fiber inspection device, such as an optical fiber microscope) and a tip 112. FIG. 1A shows an angled, exploded, side view of the optical cable 102, the optical connector 104, the bulkhead adapter 106, and the optical fiber inspection system 108; FIG. 1B shows an angled side view of the optical cable 102, the optical connector 104, the bulkhead adapter 106, and the optical fiber inspection system 108 (e.g., when connected, as described herein); and FIG. 1C shows a side view of the optical cable 102 and the optical connector 104, and a cross-section view of the bulkhead adapter 106 and the optical fiber inspection system 108 (e.g., when connected, as described herein).

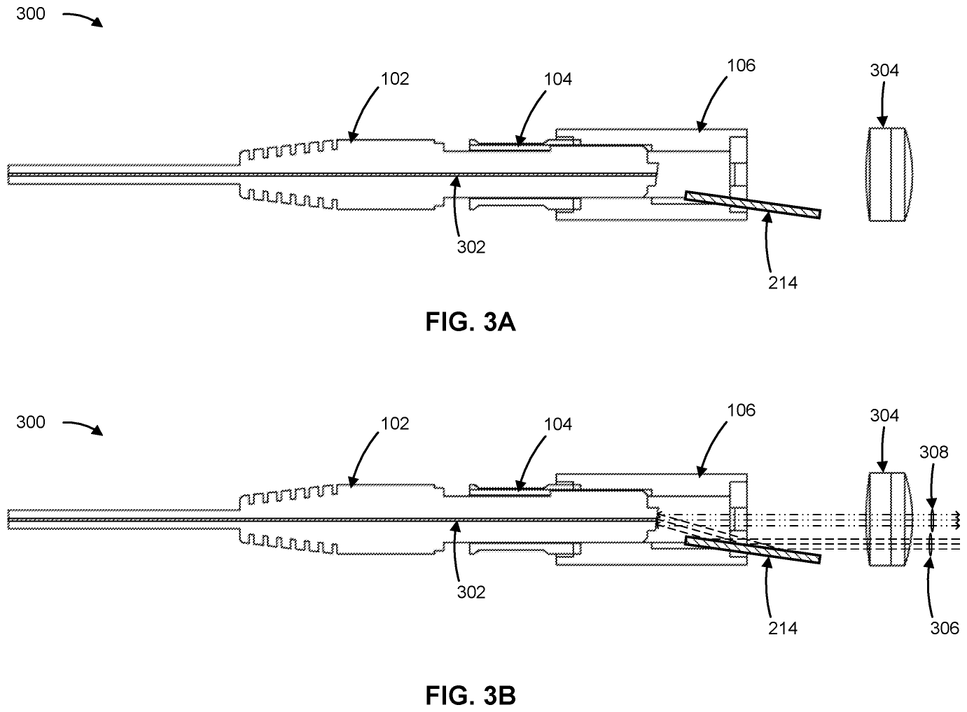

The optical cable 102 may include one or more optical fibers (not shown in FIGS. 1A-1C; see examples shown in FIGS. 3A-3B, 4A-4B, and 5A-5B). For example, an optical fiber may be disposed within a central region of the optical cable 102, along a length of the optical cable 102. As another example, the optical cable 102 may include a plurality of optical fibers arranged in an optical fiber package that is disposed within the central region of the optical cable 102, along the length of the optical cable 102. The plurality of optical fibers may be arranged, for example, in a one-dimensional array or a two-dimensional array within the optical fiber package (e.g., in a cross-section view of the optical fiber package). In some implementations, the optical cable 102 may include a ferrule comprising metal, ceramic, high-quality plastic, and/or the like, and the ferrule may have a hollowed-out center that holds and/or grips the one or more optical fibers.

The optical connector 104 may be attached to the optical cable 102. The optical connector 104 may include any fiber optic connector that includes an optical fiber, such as a fiber-optic connector (FC), an FC/physical content (PC) connector, an FC/angled physical content (APC) connector, a snap-in connector (SC), a straight tip (ST) connector, and/or a small-form factor (LC) connector, among other examples.

The one or more optical fibers of the optical cable 102 may extend from an end of the optical cable 102 and into the optical connector 104. For example, each optical fiber may extend into and terminate within the optical connector 104, with an end face that is exposed with the optical connector 104. The end face may be angled (e.g., at a non-zero angle to a longitudinal axis of the optical fiber). The end face may be, for example, polished at a precise angle, such as eight degrees (e.g., within a tolerance of 1 degree).

In some implementations, each optical fiber may be mounted in an interstitial material within the optical connector 104 (e.g., when the optical connector 104 is connected to the optical cable 102). Furthermore, the optical connector 104 may include a connector body, which may comprise metal or plastic, and the connector body may provide a structure to hold the ferrule of the optical cable 102 and/or attach to a jacket of the optical cable 102.

The bulkhead adapter 106 may be attached to the optical connector 104. The bulkhead adapter 106 may facilitate connection between the optical cable 102 (and/or the optical connector 104) and another optical cable (and/or another optical connector). In some implementations, the optical connector 104 may further include a coupling mechanism that is used to hold the optical connector 104 in place when attached to the bulkhead adapter 106. Accordingly, the bulkhead adapter 106 may have a geometry that is designed to mate with the coupling mechanism of the optical connector 104, whereby physical characteristics of the bulkhead adapter 106 (e.g., shape, size, and/or pattern) may vary depending on the type of the optical connector 104 to be attached to the bulkhead adapter 106. The bulkhead adapter 106 may include an adapter body, which may comprise metal or plastic.

As further shown in FIGS. 1A-1C, the optical fiber inspection system 108 may include the device 110 (e.g., an optical fiber inspection device, such as an optical fiber microscope) and the tip 112 (e.g., an inspection tip, such as for an optical fiber inspection device). The device 110 may include one or more components to capture and/or analyze an image or video of an end face of an optical fiber, of the one or more optical fibers included in the optical cable 102, when the optical connector 104 is connected to the optical cable 102 and/or when the bulkhead adapter 106 is attached to the optical connector 104. For example, the device 110 may include (e.g., housed within the device 110) one or more optical components, such as a lens (not shown in FIGS. 1A-1C; see examples shown in FIGS. 3A-3B, 4A-4B, and 5A-5B), a light source (e.g., a light emitting diode (LED), or another type of light source; not shown in FIGS. 1A-1C;), and a sensor (e.g., an image sensor, a video sensor, and/or another type of sensor; not shown in FIGS. 1A-1C;), and/or one or more other components. In some implementations, the device 110 may be configured to use coaxial illumination (e.g., bright field illumination) to illuminate the end face of the optical fiber, such that illumination light passes through a lens of the device 110 and propagates to the end face of the optical fiber. The device 110 may also be configured to allow reflected light (e.g., reflected illumination light), reflected by the end face of the optical fiber, to pass through the lens and to the sensor, which enables the sensor to generate sensor data (e.g., an image, a video, or other sensor data) associated with the end face of the optical fiber.

The tip 112 may be an optical assembly that is configured to attach to the device 110 (e.g., to an end of the device 110, such as an end of the device 110 associated with the lens described above). For example, the tip 112 may be an independent component (e.g., that is not included in the device 110) and may be configured to attach to (e.g., screw on or clip to, among other examples) the device 110 (e.g., the end of the device 110), or otherwise interface with the device 110, such as shown in FIGS. 1A-1C. Alternatively, the tip 112 may be an integrated component of the device 110, such that the tip 112 and the device 110 form a monolithic structure. Accordingly, in some implementations, the tip 112 may be a component of the device 110.

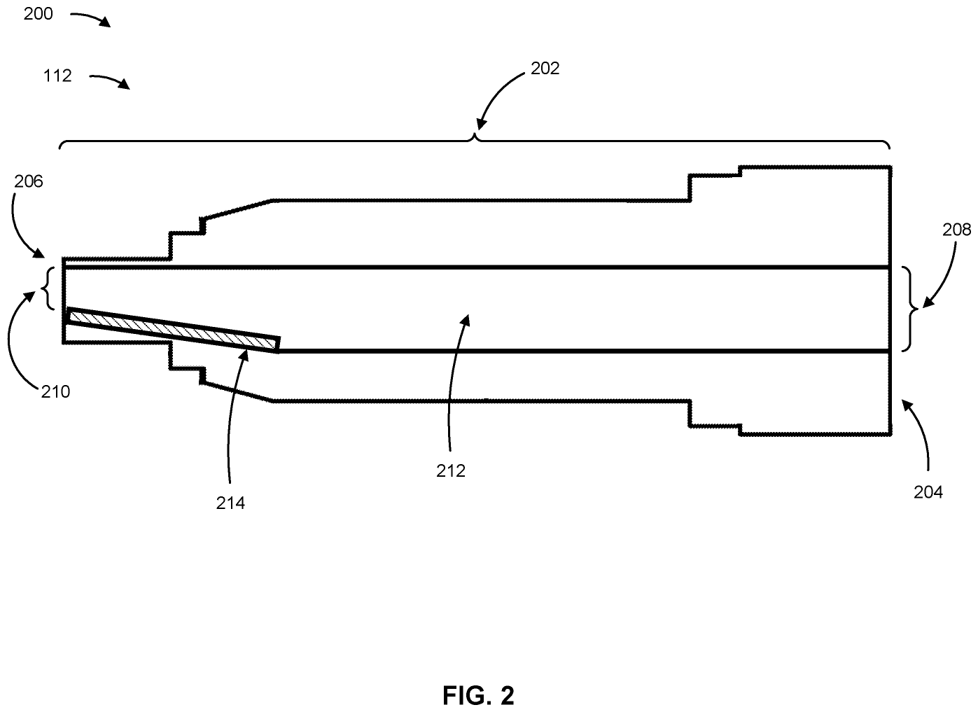

Additionally, the tip 112 may be configured to interface with at least one of the optical connector 104 or the bulkhead adapter 106 (e.g., to facilitate the device 110 capturing an image and/or video of an end face of an optical fiber of the optical cable 102). For example, as shown in FIG. 1A-1B, the tip 112 may be configured to insert into the bulkhead adapter 106 and to contact respective interior surfaces of the optical connector 104 and/or the bulkhead adapter 106. Further description related to the tip 112 is described herein in association with FIG. 2.

As indicated above, FIGS. 1A-1C are provided as one or more examples. Other examples may differ from what is described with regard to FIGS. 1A-1C. In practice, there may be additional components, fewer components, different components, or differently arranged components than those shown in FIGS. 1A-1C.

FIG. 2 is a diagram of an example implementation 200 of the tip 112 described herein. As shown in FIG. 2, the tip 112 may include a body portion 202, which may include a first end 204 and a second end 206. The first end 204 may include a first opening 208, and the second end 206 may include a second opening 210. Accordingly, a chamber 212 may be formed within the body portion 202 of the tip 112, and may extend (e.g., within the body portion 202) from the first opening 208 of the first end 204 to the second opening 210 of the second end 206.

In some implementations, the tip 112 may include an optical element 214. For example, as shown in FIG. 2, the optical element 214 may be disposed on a surface of the chamber 212 of the body portion 202 of the tip 112. That is, the optical element 214 may be included in an internal environment of the tip 112 (e.g., that is defined by the chamber 212). In some implementations, the optical element 214 may cover a portion of the surface of the chamber 212 or, alternatively, may cover an entirety of the surface of the chamber 212.

The optical element 214 may be configured to have at least one of a reflective characteristic, a refractive characteristic, or a non-diffractive characteristic. For example, the optical element 214 may include a reflective element (e.g., a reflector, a mirror, or a similar element), a refractive element (e.g., a prism), and/or another type of non-diffractive element. The optical element 214 may include one or more planar portions and/or one or more non-planar portions. While some implementations described herein include the optical element 214 as an independent component included in the internal environment of the tip 112, the optical element 214 may be an integrated component of the chamber 212. Additionally, or alternatively, a portion of the surface of the chamber 212 (e.g., instead of, or in addition to, the optical element 214) may be configured to have at least one of the reflective characteristic, the refractive characteristic, or the non-diffractive characteristic. Accordingly, the portion of the surface of the chamber 212 may have a same or similar configuration or functionality as the optical element 214 described elsewhere herein.

In some implementations, the body portion 202 of the tip 112 may be configured to allow illumination light (e.g., from the light source of the device 110) to enter through the first opening 208 of the first end 204 of the body portion 202 and to propagate to, and impinge on, the optical element 214 (or onto the portion of the surface of the chamber 212). For example, the first end 204 of the body portion 202 of the tip 112 may contact an end of the device 110 (e.g., when the tip 112 is attached to the end of the device 110, as shown in FIGS. 1B-1C), which may allow illumination light (e.g., generated by the light source of the device 110) to propagate from the end of the device 110 through the first opening 208 of the first end 204 of the body portion 202 to the optical element 214 (or to the portion of the surface of the chamber 212). In some implementations, the illumination light may be associated with coaxial illumination (e.g., bright field illumination). For example, the illumination light may propagate via the lens of the device 110 (e.g., via a perimeter zone of the lens, which does not include a central zone of the lens) and through the first opening 208 of the first end 204 of the body portion 202 to the optical element 214.

The optical element 214 (or the portion of the surface of the chamber 212) may be configured to redirect the illumination light, such as to allow the illumination light to propagate to, and exit through, the second opening 210 of the second end 206 of the body portion 202 and thereby propagate to an end face (e.g., an angled end face) of an optical fiber of the optical cable 102 (e.g., that is positioned at an end of the optical cable 102 and that is recessed within at least one of the optical connector 104 or the bulkhead adapter 106). For example, the optical element 214 (or the portion of the surface of the chamber 212) may reflect, refract, or otherwise cause the illumination light to propagate to, and exit through, the second opening 210 of the second end 206 of the body portion 202. Further, the tip 112 (e.g., when configured to interface with at least one of the optical connector 104 or the bulkhead adapter 106) may allow the second opening 210 of the second end 206 of the body portion 202 of the tip 112 to be proximate to the end face of the optical fiber (e.g., a distance between the second opening 210 and the end face of the optical fiber may be less than or equal to 1 millimeter (mm), 2 mm, or 3 mm). Accordingly, the illumination light, after exiting through the second opening 210, may propagate to the end face of the optical fiber of the optical cable 102.

In some implementations, the body portion 202 of the tip 112 may include an adjustment component (not shown in FIG. 2) that is configured to adjust the optical element 214. For example, the adjustment component may be a knob, a lever, or another type of adjustment component that may attach to, or interface with, the optical element 214. Adjustment of the adjustment component may thereby enable adjustment of the optical element 214. In some implementations, the adjustment component may be configured to adjust an orientation angle of the optical element 214 with respect to a reference axis (e.g., that extends from the first opening 208 of the first end 204 to the second opening 210 of the second end 206 of the body portion 202 of the tip 112). Accordingly, the adjustment component may be adjusted to cause the optical element 214 to be oriented to allow the optical element 214 to redirect the illumination light, such as to allow the illumination light to propagate to, and exit through, the second opening 210 of the second end 206 of the body portion 202 and thereby propagate to the end face of the optical fiber of the optical cable 102.

In some implementations, the body portion 202 of the tip 112 may be configured to allow reflection light to enter through the second opening 210 of the second end 206 of the body portion 202 and to propagate through, and exit from, the chamber 212 of the body portion 202. For example, a portion of the illumination light that propagates to the angled end face of the optical fiber of the optical cable 102 (e.g., after exiting through the second opening 210) may be reflected, by the end face of the optical fiber, back to the second opening 210. This reflection light (e.g., the reflected portion of the illumination light) then may enter through the second opening 210 and may propagate through, and exit from, the chamber 212.

In some implementations, the body portion 202 may be configured to allow the reflection light to propagate to, and exit through, the first opening 208 of the first end 204 of the body portion 202. Alternatively, the body portion 202 may be configured to allow the reflection light to propagate to, and exit through, a third opening (not shown) of the body portion 202 (e.g., another opening other than the first opening 208 of the first end 204 and the second opening 210 of the second end 206).

Accordingly, the body portion 202 of the tip 112 may be configured to allow the reflection light to propagate to the device 110 (e.g., after exiting from the chamber 212, such as via the first opening 208 of the first end 204 or the third opening of the body portion 202). For example, the body portion 202 of the tip 112 may allow the reflection light to propagate to the end of the device 110 (e.g., when the tip 112 is attached to the end of the device 110, as shown in FIGS. 1B-1C). In a specific example, the reflection light may propagate to the lens of the device 110 (e.g., to the central zone of the lens). Further, the reflection light may pass through the lens and form an image of the end face of the optical fiber at the image sensor of the device 110. In this way, the tip 112 (and the body portion 202 of the tip 112) may be configured to allow the device 110 to image the end face (e.g., the angled end face) of the optical fiber (e.g., using coaxial illumination, such as bright field illumination).

As indicated above FIG. 2 is provided as an example. Other examples may differ from what is described with regard to FIG. 2. In practice, there may be additional components, fewer components, different components, or differently arranged components than those shown in FIG. 2.

FIGS. 3A-3B are diagrams of one or more example implementations 300 described herein. FIGS. 3A-3B illustrate how the optical element 214 (e.g., of the tip 112), when the optical element 214 is configured to have a reflective characteristic (e.g., when the optical element 214 includes a reflector, a mirror, or a similar type of component), may be used to illuminate an angled end face of an optical fiber 302 of the optical cable 102 (e.g., when the angled end face is recessed within the optical connector 104 and/or the bulkhead adapter 106).

As shown in FIG. 3A, the optical element 214 may be oriented at an angle to an optical axis of a lens 304 (e.g., that is included in the device 110). As shown in FIG. 3B, illumination light 306 (e.g., that is emitted by the light source of the device 110) may propagate via the lens 304 (e.g., via a perimeter zone of the lens 304) to the optical element 214 (e.g., via the first opening 208 of the first end 204 of the body portion 202 of the tip 112, as described elsewhere herein). The optical element 214 may redirect the illumination light 306 (e.g., by reflecting the illumination light 306), and may thereby cause the illumination light 306 to propagate (e.g., via the second opening 210 of the second end 206 of the body portion 202 of the tip 112) to the angled end face of the optical fiber 302.

As shown in FIG. 3B, a portion of the illumination light 306 that propagates to the angled end face of the optical fiber 302 (e.g., after exiting through the second opening 210) may be reflected by the angled end face of the optical fiber 302. This may form reflection light 308, which may propagate to the lens 304, such as via the second opening 210 of the second end 206 of the body portion 202 of the tip 112, the chamber 212 of the body portion 202 of the tip 112, and the first opening 208 of the first end 204 of the body portion 202 of the tip 112 (or another opening of the body portion 202 of the tip 112). As shown in FIG. 3B, the reflection light 308 may propagate to the central zone of the lens 304, which may allow the reflection light 308 to pass through the lens 304 and form an image of the end face of the optical fiber 302 at the image sensor of the device 110. In this way, the optical element 214 may be configured to allow the device 110 to image the angled end face of the optical fiber 302 (e.g., using coaxial illumination, such as bright field illumination).

As indicated above, FIGS. 3A-3B are provided as one or more examples. Other examples may differ from what is described with regard to FIGS. 3A-3B. In practice, there may be additional components, fewer components, different components, or differently arranged components than those shown in FIGS. 3A-3B.

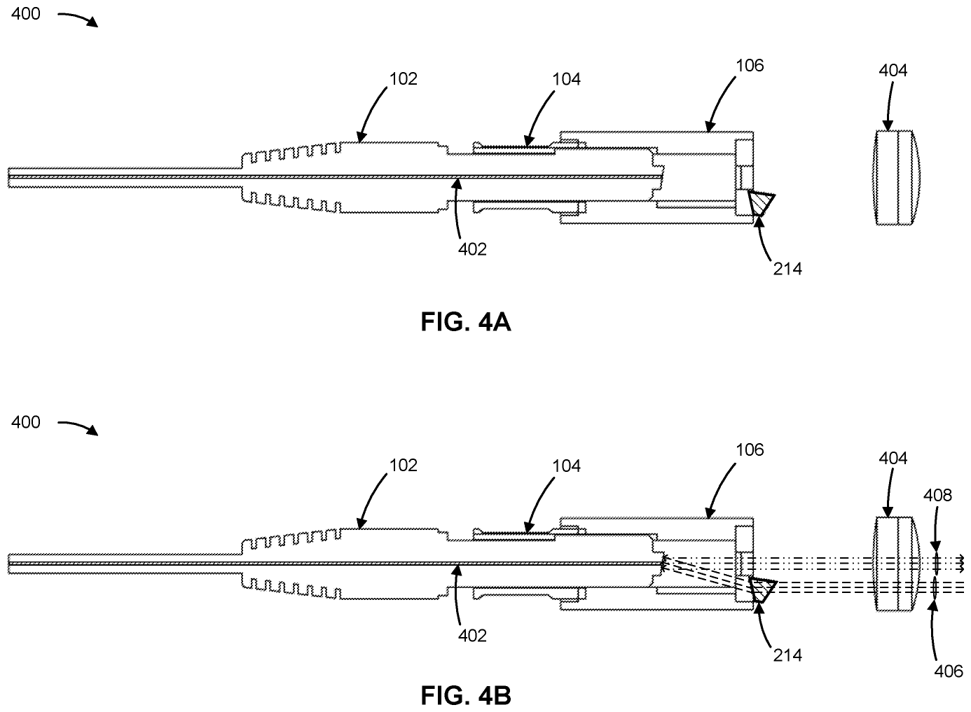

FIGS. 4A-4B are diagrams of one or more example implementations 400 described herein. FIGS. 4A-4B illustrate how the optical element 214 (e.g., of the tip 112), when the optical element 214 is configured to have a refractive characteristic (e.g., when the optical element 214 includes a prism or a similar type of component), is used to illuminate an angled end face of an optical fiber 402 of the optical cable 102 (e.g., when the angled end face is recessed within the optical connector 104 and/or the bulkhead adapter 106).

As shown in FIG. 4A, the optical element 214 may be positioned proximate to the angled end face of the optical fiber 402. As shown in FIG. 4B, illumination light 406 (e.g., that is emitted by the light source of the device 110) may propagate via a lens 404 (e.g., that is included in the device 110), such as via a perimeter zone of the lens 404, to the optical element 214 (e.g., via the first opening 208 of the first end 204 of the body portion 202 of the tip 112, as described elsewhere herein). The optical element 214 may redirect the illumination light 406 (e.g., by refracting the illumination light 406), and thereby cause the illumination light 406 to propagate (e.g., via the second opening 210 of the second end 206 of the body portion 202 of the tip 112) to the angled end face of the optical fiber 402.

As shown in FIG. 4B, a portion of the illumination light 406 that propagates to the angled end face of the optical fiber 402 (e.g., after exiting through the second opening 210) may be reflected by the angled end face of the optical fiber. This may form reflection light 408, which may propagate to the lens 404, such as via the second opening 210 of the second end 206 of the body portion 202 of the tip 112, the chamber 212 of the body portion 202 of the tip 112, and the first opening 208 of the first end 204 of the body portion 202 of the tip 112 (or another opening of the body portion 202 of the tip 112). As shown in FIG. 4B, the reflection light 408 may propagate to the central zone of the lens 404, which may allow the reflection light 408 to pass through the lens 404 and form an image of the end face of the optical fiber 402 at the image sensor of the device 110. In this way, the optical element 214 may be configured to allow the device 110 to image the angled end face of the optical fiber 402 (e.g., using coaxial illumination, such as bright field illumination).

As indicated above, FIGS. 4A-4B are provided as one or more examples. Other examples may differ from what is described with regard to FIGS. 4A-4B. In practice, there may be additional components, fewer components, different components, or differently arranged components than those shown in FIGS. 4A-4B.

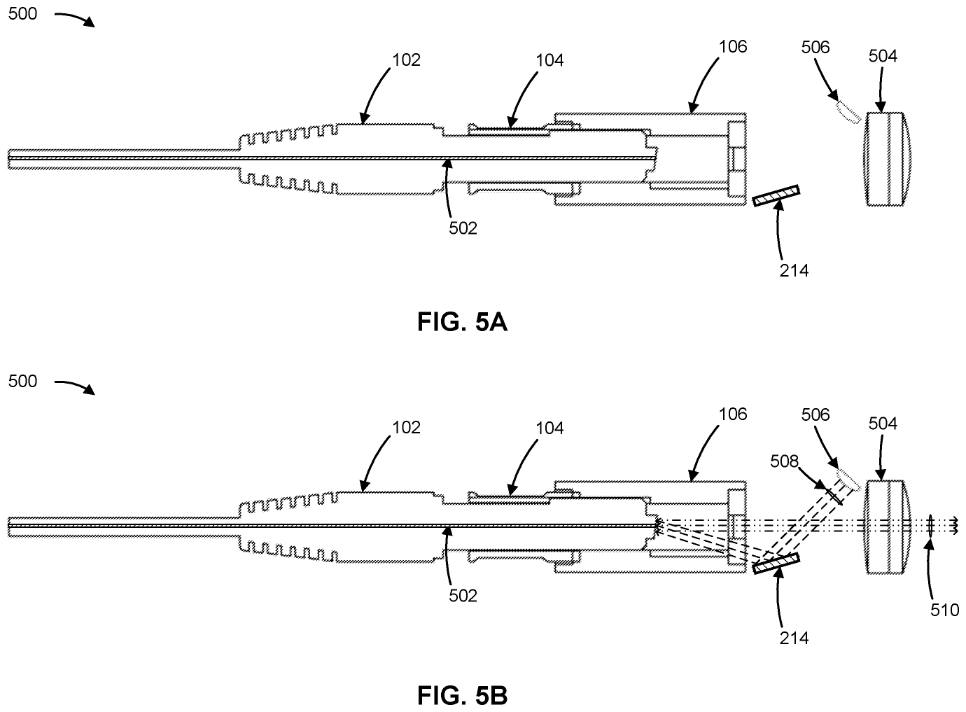

FIGS. 5A-5B are diagrams of one or more example implementations 500 described herein. FIGS. 5A-5B illustrate how the optical element 214 (e.g., of the tip 112), when the optical element 214 is configured to have a reflective characteristic (e.g., when the optical element 214 includes a reflector, a mirror, or a similar type of component), is used to illuminate an angled end face of an optical fiber 502 of the optical cable 102 (e.g., when the angled end face is recessed within the optical connector 104 and/or the bulkhead adapter 106).

As shown in FIG. 5A, the optical element 214 may be oriented at an angle to an optical axis of a lens 504 (e.g., that is included in the device 110) and an emission axis of a light source 506 (e.g., that is included in the device 110, or that is independent of the device 110). Notably, the optical axis of the lens 504 and the emission axis of the light source 506 are not parallel, and, accordingly, coaxial illumination, such as bright field illumination, is not used in the one or more example implementations 500.

As shown in FIG. 5B, illumination light 508 may be emitted by the light source 506 and may propagate to the optical element 214 (e.g., via the first opening 208 of the first end 204 of the body portion 202 of the tip 112, as described elsewhere herein). The optical element 214 may redirect the illumination light 508 (e.g., by reflecting the illumination light 508), and thereby cause the illumination light 508 to propagate (e.g., via the second opening 210 of the second end 206 of the body portion 202 of the tip 112) to the angled end face of the optical fiber 502.

As shown in FIG. 5B, a portion of the illumination light 508 that propagates to the angled end face of the optical fiber 502 (e.g., after exiting through the second opening 210) may be reflected by the angled end face of the optical fiber 502. This may form reflection light 510, which may propagate to the lens 504, such as via the second opening 210 of the second end 206 of the body portion 202 of the tip 112, the chamber 212 of the body portion 202 of the tip 112, and a third opening of the body portion 202 of the tip 112. As shown in FIG. 5B, the reflection light 510 may propagate to the central zone of the lens 504, which may allow the reflection light 510 to pass through the lens 504 and form an image of the end face of the optical fiber 502 at the image sensor of the device 110. In this way, the optical element 214 may be configured to allow the device 110 to image the angled end face of the optical fiber 502 (e.g., using non-coaxial illumination).

As indicated above, FIGS. 5A-5B are provided as one or more examples. Other examples may differ from what is described with regard to FIGS. 5A-5B. In practice, there may be additional components, fewer components, different components, or differently arranged components than those shown in FIGS. 5A-5B.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A tip for an optical fiber inspection device, comprising:
a body portion that includes a first end with a first opening, a second end with a second opening, and a chamber that extends within the body portion from the first opening of the first end to the second opening of the second end; and
an optical element disposed on a surface of the chamber of the body portion, wherein:
the body portion is configured to allow illumination light to enter through the first opening of the first end of the body portion and to propagate to, and impinge on, the optical element,
the optical element is configured to redirect the illumination light to allow the illumination light to propagate to, and exit through, the second opening of the second end of the body portion and thereby propagate to an angled end face of an optical fiber, and
the body portion is configured to allow reflection light, reflected by the angled end face of the optical fiber, to enter through the second opening of the second end of the body portion and to propagate to, and exit through, the first opening of the first end of the body portion and thereby propagate to the optical fiber inspection device.

2. The tip of claim 1, wherein the tip is configured to allow the optical fiber inspection device to image the angled end face of the optical fiber using bright field illumination.

3. The tip of claim 1, wherein the tip is an independent component configured to attach to an end of the optical fiber inspection device, wherein the first end of the body portion contacts the end of the optical fiber inspection device when the tip is attached to the end of the optical fiber inspection device.

4. The tip of claim 1, wherein the tip is an integrated component of the optical fiber inspection device.

5. The tip of claim 1, wherein the body portion is configured to allow the reflection light, after exiting through the first opening of the first end of the body portion, to propagate to a central zone of a lens of the optical fiber inspection device.

6. The tip of claim 1, wherein the tip further includes an adjustment component that is configured to adjust an orientation angle of the optical element with respect to a reference axis that extends from the first opening of the first end to the second opening of the second end.

7. The tip of claim 1, wherein the optical fiber is included in an optical cable, and the angled end face of the optical fiber is positioned at an end of the optical cable that is recessed within at least one of an optical connector or a bulkhead adapter,
wherein the tip is configured to interface with at least one of the optical connector or the bulkhead adapter to allow the second opening of the second end of the body portion of the tip to be proximate to the angled end face of the optical fiber.

8. The tip of claim 1, wherein the optical element is configured to have at least one of a reflective characteristic or a refractive characteristic.

9. A tip for an optical fiber inspection device, comprising:
a body portion that includes a first opening, a second opening, and a chamber that extends within the body portion from the first opening to the second opening, wherein:
the body portion is configured to allow illumination light to enter through the first opening of the body portion and to propagate to, and impinge on, a portion of a surface of the chamber,
the portion of the surface of the chamber is configured to redirect the illumination light to allow the illumination light to propagate to, and exit through, the second opening of the body portion and thereby propagate to an angled end face of an optical fiber, and
the body portion is configured to allow reflection light, reflected by the angled end face of the optical fiber, to enter through the second opening of the body portion and to propagate through, and exit from, the chamber of the body portion and thereby propagate to the optical fiber inspection device.

10. The tip of claim 9, wherein the tip is configured to allow the optical fiber inspection device to image the angled end face of the optical fiber using bright field illumination.

11. The tip of claim 9, wherein the tip is an independent component configured to attach to an end of the optical fiber inspection device.

12. The tip of claim 9, wherein the tip is an integrated component of the optical fiber inspection device.

13. The tip of claim 9, wherein the body portion is configured to allow the reflection light to exit the body portion through the first opening of the body portion.

14. The tip of claim 9, wherein the body portion is configured to allow the reflection light to exit the body portion through a third opening of the body portion.

15. The tip of claim 9, wherein the optical fiber is included in an optical cable, and the angled end face of the optical fiber is positioned at an end of the optical cable that is recessed within at least one of an optical connector or a bulkhead adapter,
wherein the tip is configured to interface with at least one of the optical connector or the bulkhead adapter.

16. The tip of claim 9, wherein the portion of the surface of the chamber is configured to have at least one of a reflective characteristic or a refractive characteristic.

17. An optical assembly, comprising:
a body portion that includes a first opening, a second opening, and a chamber that extends within the body portion from the first opening to the second opening, wherein:
the body portion is configured to allow illumination light to enter through the first opening of the body portion and to propagate to, and impinge on, a portion of a surface of the chamber,
the portion of the surface of the chamber is configured to redirect the illumination light to allow the illumination light to propagate to, and exit through, the second opening of the body portion and thereby propagate to an angled end face of an optical fiber, and
the body portion is configured to allow reflection light, reflected by the angled end face of the optical fiber, to enter through the second opening of the body portion and to propagate through, and exit from, the chamber of the body portion.

18. The optical assembly of claim 17, wherein the optical assembly is an independent component configured to attach to an optical fiber inspection device.

19. The optical assembly of claim 17, wherein the optical assembly is an integrated component of an optical fiber inspection device.

20. The optical assembly of claim 17, wherein the portion of the surface of the chamber is configured to have at least one of a reflective characteristic or a refractive characteristic.
